(19) United States
(12) Patent Application Publication
(10) Pub. No.: US 2026/0275947 A1
(43) Pub. Date: Sep. 17, 2026

(54) FUEL INJECTION DEVICE

(71) Applicant: MITSUBISHI HEAVY INDUSTRIES ENGINE & TURBOCHARGER, LTD., Sagamihara-shi, Kanagawa (JP)

(72) Inventor: Hisao OGAWA, Sagamihara-shi (JP)

(73) Assignee: MITSUBISHI HEAVY INDUSTRIES ENGINE & TURBOCHARGER, LTD., Sagamihara-shi, Kanagawa (JP)

(21) Appl. No.: 19/168,793

(22) PCT Filed: Jan. 25, 2024
(86) PCT No.: PCT/JP2024/002198

§ 371 Date: Sep. 24, 2025

(30) Foreign Application Priority Data
Mar. 30, 2023 (JP) 2023-056522

(51) Int. Cl. F02M 55/00; F02M 63/00

(52) U.S. Cl. CPC F02M 55/008; F02M 63/0021; F02M 2200/28

(57) ABSTRACT

One embodiment of a fuel injection device according to the present disclosure is provided with: a casing in which a fuel injection hole is formed at the leading end thereof and a fuel passage is formed thereinside; a spool including a needle valve that is disposed so as to be movable along the axial direction of the casing by the operation of an electromagnetic actuator and that is capable of opening and closing the fuel injection hole, and a drive piston that faces a pressure control chamber in communication with the fuel passage; and a pressure reduction flow passage formation member having formed therein a pressure reduction flow passage that has an opening formed in a facing surface facing a piston surface and an outlet port to be opened and closed by the operation of the electromagnetic actuator, and that is in communication with the pressure control chamber. The piston surface has a protruding part that protrudes to the opening side, and the pressure reduction flow passage formation member has an inclined surface that is inclined so as to have a diameter which decreases from the opening along a direction away from the piston surface. The protruding part has a linear contact portion capable of linearly contacting with the inclined surface and closing the opening when the piston surface moves to the other end side.

### TECHNICAL FIELD

The present disclosure relates to a fuel injection device.

The present application claims priority based on Japanese Patent Application No. 2023-056522 filed in Japan on Mar. 30, 2023, the contents of which are incorporated herein by reference.

### BACKGROUND ART

As a fuel injection system of a diesel engine, an electronic control method including a common rail has been widely used. In many cases, a fuel injection system of an electronic control method employs a high-speed response solenoid valve to control fuel injection. In the fuel injection method, as a general structure, the pressure control chamber communicating with the fuel passage applies a fuel pressure to the drive piston connected to the fuel injector, thereby closing the fuel injection hole. On the other hand, the pressure control chamber is opened by the solenoid valve, and the pressure control chamber is depressurized to open the fuel injection hole, and thereby, fuel injection is performed. Thereafter, when the pressure control chamber is closed again by the solenoid valve, the fuel pressure in the pressure control chamber is restored, and the fuel injector closes the fuel injection hole to end the injection.

Fuel injection devices having the above-described configuration are disclosed in PTL 1 and PTL 2.

### CITATION LIST

### Patent Literature

[PTL 1] PCT International Publication No. WO2007/100425
[PTL 2] German Patent Application, Publication No. 102016219337

### SUMMARY OF INVENTION

### Technical Problem

In the fuel injection system as described above, the fuel injection is performed by leaking the fuel from the pressure control chamber to depressurize the pressure control chamber. Therefore, a fuel discharge amount of the fuel injection device is the sum of a fuel injection amount injected from the fuel injection hole and the leakage leaked from the pressure control chamber. Therefore, reducing the leakage and improving the ratio (injection efficiency) of the fuel injection amount to the sum of the fuel discharge amounts leads to a reduction in the energy consumption of a high-pressure pump used for fuel injection. In addition, it is possible to suppress an increase in the temperature of the leaked fuel, and to reduce deterioration of the fuel and the amount of the cooler that cools the fuel.

Means for improving the above-described injection efficiency are disclosed in PTLs 1 and 2, but it is considered that the means are not sufficient.

The present disclosure has been made in view of the above-described circumstances, and an object of the present disclosure is to reduce a leakage of fuel leaking from a pressure control chamber to improve an injection efficiency.

### Solution to Problem

In order to achieve the above object, an aspect of the present disclosure provides a fuel injection device configured to inject fuel by a solenoid actuator, the fuel injection device including:
a casing in which a fuel injection hole is formed in a tip portion and a fuel passage that allows the fuel injection hole and a fuel inlet port to communicate with each other is formed inside the casing;
a spool disposed inside the casing to be movable along an axial direction of the casing by operation of the solenoid actuator, the spool including
   a needle valve disposed on one end side of the spool to be capable of opening and closing the fuel injection hole, and
   a drive piston having a piston surface disposed on the other end side of the spool to face a pressure control chamber that communicates with the fuel passage; and
a depressurization flow passage formation member having an outlet port that is opened and closed by the operation of the solenoid actuator and an opening formed on a facing surface facing the piston surface, the depressurization flow passage formation member having a depressurization flow passage that communicates with the pressure control chamber and that is formed inside the depressurization flow passage formation member,
in which the piston surface has a protruding part that protrudes toward an opening side, and the depressurization flow passage formation member has an inclined surface that is inclined from the opening to be tapered in a direction away from the piston surface, and
the protruding part has a linear contact portion that comes into linear contact with the inclined surface and is capable of closing the opening when the piston surface is moved to the other end side.

### Advantageous Effects of Invention

According to the aspect of the fuel injection device of the present disclosure, the leakage of the fuel that is discharged (leaked) from the pressure control chamber via the depressurization flow passage at the time of fuel injection can be reduced, and thus, the injection efficiency can be improved.

### BRIEF DESCRIPTION OF DRAWINGS

FIG. 1 is a schematic vertical cross-sectional view showing a fuel injection device according to an embodiment.

FIG. 2 is an enlarged vertical cross-sectional view showing a part of the fuel injection device shown in FIG. 1.

FIG. 3 is a view showing a part of the fuel injection device shown in FIG. 2 in a further enlarged manner.

FIG. 4 is an enlarged vertical cross-sectional view showing a part of a fuel injection device according to another embodiment and showing a vicinity of a pressure control chamber.

FIG. 5 is an enlarged vertical cross-sectional view showing a part of a fuel injection device according to still another embodiment and showing a vicinity of a pressure control chamber.

FIG. 6 is a schematic vertical cross-sectional view showing a fuel injection device according to another embodiment.

FIG. 7 is an enlarged vertical cross-sectional view showing a part of the fuel injection device shown in FIG. 6.

FIG. 8 is a vertical cross-sectional view showing a part of the fuel injection device according to still another embodiment.

FIG. 9 is a schematic vertical cross-sectional view showing a part of a fuel injection device in the related art.

### DESCRIPTION OF EMBODIMENTS

Hereinafter, some embodiments of the present invention will be described with reference to the accompanying drawings. Dimensions, materials, shapes, and relative dispositions of components described in the embodiments or shown in the drawings are not intended to limit the scope of the present invention, and are merely examples for description.

For example, expressions representing relative or absolute dispositions such as “in a certain direction”, “along a certain direction”, “parallel”, “orthogonal”, “center”, “concentric”, or “coaxial” not only strictly represent the dispositions, but also represent a state where the dispositions are relatively displaced with a tolerance or at an angle or a distance to such an extent that the same function can be obtained.

For example, expressions representing that things are in an equal state such as “same”, “equal”, and “homogeneous” not only strictly represent an equal state, but also represent a state where a difference exists with a tolerance or to such an extent that the same function can be obtained.

For example, expressions representing shapes such as a quadrangular shape and a cylindrical shape not only represent shapes such as a quadrangular shape and a cylindrical shape in a geometrically strict sense, but also represent shapes including an uneven portion or a chamfered portion within a range where the same effect can be obtained.

Meanwhile, expressions “being provided with”, “being equipped with”, “including”, or “having” one component are not exclusive expressions excluding the presence of other components.

### (Configuration of Fuel Injection Device)

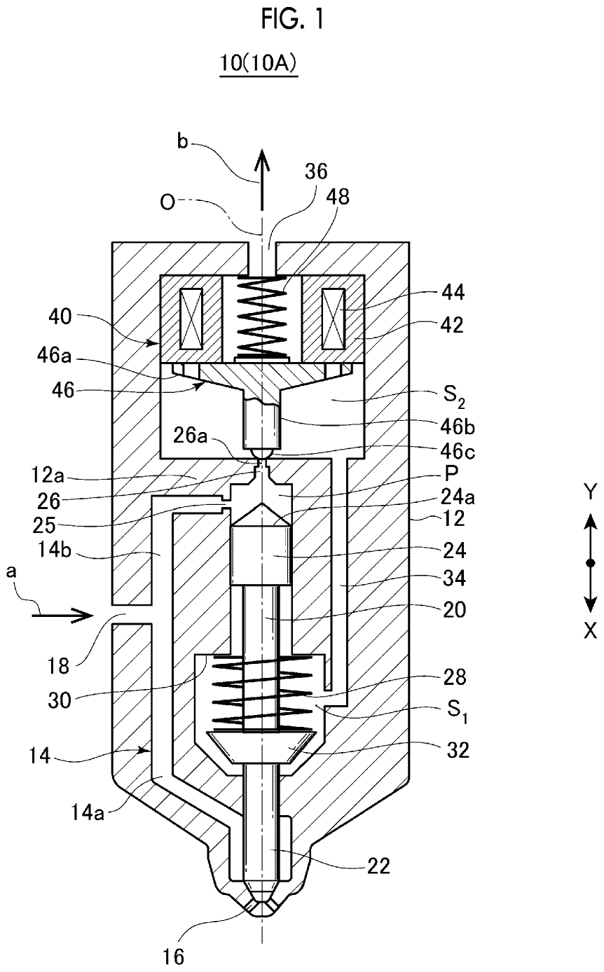

FIG. 1 is a schematic vertical cross-sectional view showing an embodiment of a fuel injection device according to the present disclosure.

As shown in FIG. 1, a fuel passage 14 is formed inside a casing 12 of a fuel injection device 10A, and the fuel passage 14 communicates with at least one fuel injection hole 16 formed in a tip portion of the casing 12 and a fuel inlet port 18. A high-pressure fuel is supplied to the fuel passage 14 from a high-pressure fuel pipe (not shown) via the fuel inlet port 18 as indicated by an arrow a. For example, in a case where the fuel injection device 10 is applied to a common rail type fuel injection system provided in a diesel engine, high-pressure fuel stored in a pressure accumulating pipe called a “common rail”, which is a type of surge tank, is supplied to the fuel passage 14.

In FIG. 1, a tip side direction of the casing 12 in which the fuel injection hole 16 is provided in the body of the casing 12 is set as an X direction, and a direction opposite to the X direction is set as a Y direction.

A first space S₁ extending along the central axis O of the casing 12 is formed inside the casing 12, and the spool 20 is disposed in the first space S₁ to be movable along the axial direction of the casing 12 (hereinafter, also simply referred to as an “axial direction”). A needle valve 22 is provided on one end side (X-direction side) of the spool 20, and a drive piston 24 is provided on the other end side (Y-direction side) of the spool 20. The fuel passage 14 is branched into a fuel passage 14a that communicates with the fuel injection hole 16 inside the casing 12 and a fuel passage 14b that communicates with the pressure control chamber P via the inlet orifice 25. At the other end side of the spool 20, a pressure control chamber P is formed in a region on the Y-direction side of the first space S₁, facing a partition wall 12a, and a piston surface 24a of a drive piston 24 is disposed to face the pressure control chamber P.

The needle valve 22 reciprocates along the central axis O together with the spool 20, so that the fuel injection hole 16 is opened and closed. The high-pressure fuel is injected from the opened fuel injection hole 16 into the combustion chamber (not shown) of the internal combustion engine.

A second space S₂ is formed on the Y-direction side from the first space S₁ with the partition wall 12a interposed therebetween. A depressurization flow passage 26 that communicates with the pressure control chamber P and the second space S₂ is formed in the partition wall 12a, and the depressurization flow passage 26 has an outlet orifice 26a that is open to the second space S₂. The solenoid actuator 40 is provided in the second space S₂ to open and close the outlet orifice 26a.

In the exemplary embodiment shown in FIG. 1, the spring member 28 is provided at a central portion of the spool 20 in the axial direction in the first space S₁. One end of the spring member 28 is integrally provided in the spool 20, is locked to a support table 32 having an increased diameter in a radial direction of the casing 12 (hereinafter, simply referred to as a “radial direction”), and the other end of the spring member 28 is locked to a step part 30 formed on an inner side wall of the casing 12 facing the first space S₁. The spring member 28 biases the spool 20 with a spring force in an X direction in which the needle valve 22 closes the fuel injection hole 16. When the solenoid actuator 40 is not operated, the outlet orifice 26a is closed, and at this time, the fuel pressure applied to the piston surface 24a in the pressure control chamber P and the fuel pressure applied to the needle valve 22 are balanced, and the spring force of the spring member 48 is applied to the fuel pressure in the pressure control chamber P. Therefore, the needle valve 22 is at a position where the fuel injection hole 16 is closed.

When the solenoid actuator 40 is operated and the outlet orifice 26a is opened, the fuel in the pressure control chamber P is throttled at the outlet orifice 26a from the depressurization flow passage 26 and leaks to the second space S₂, and on the other hand, the fuel flowing in from the fuel passage 14b is throttled (restricted) at the inlet orifice 25, so that the fuel pressure in the pressure control chamber P is depressurized. In this manner, the balance between the fuel pressure that is biased against the piston surface 24a and the fuel pressure that is biased against the needle valve 22 side is disrupted, and the spool 20 moves in the Y direction. Therefore, the fuel injection hole 16 is opened, and the high-pressure fuel is injected into a combustion chamber (not shown) of the engine (for example, a diesel engine or the like). When the solenoid actuator 40 is deactivated and the outlet orifice 26a is closed, the balance between the fuel pressure that is biased against the piston surface 24a and the fuel pressure that is biased against the needle valve 22 is restored, the spool 20 moves in the X direction, and the fuel injection hole 16 is closed by the needle valve 22.

In the present embodiment, the outlet orifice 26a having a throttle function is provided at the outlet portion of the depressurization flow passage 26. However, in another embodiment (not shown), an opening (outlet port) that does not have a throttle function may be provided.

In the exemplary embodiment shown in FIG. 1, the leak passage 34 communicating with the first space S₁ and the second space S₂ is formed in the casing 12, and the fuel leaking to the first space S₁ from a sliding surface between an inner wall surface of the casing 12 and the drive piston 24 or the needle valve 22 flows into the second space S₂ through the leak passage 34. Then, the fuel is discharged from the second space S₂ to the outside through the discharge port 36 formed in the casing 12 as indicated by an arrow b.

### (Configuration of Solenoid Actuator)

In the exemplary embodiment shown in FIG. 1, the solenoid actuator 40 is provided in the second space S₂ and includes a stator core 42. The stator core 42 is made of a magnetic body, incorporates a solenoid coil 44, and generates a magnetic flux when the solenoid coil 44 is energized, so that an electromagnetic force is generated from the stator core 42. Further, the armature 46 is disposed on the X-direction side of the stator core 42 in the axial direction. The armature 46 includes an enlarged diameter part 46a, a shaft portion 46b extending from the enlarged diameter part 46a along the X direction, and a valve body 46c provided at a tip of the shaft portion 46b. The enlarged diameter part 46a is disposed to face the X-direction side of the stator core 42, and the armature 46 is disposed to be reciprocable along the axial direction depending on the presence or absence of an electromagnetic force generated from the stator core 42.

A spring member 48 is provided inside the stator core 42, and a spring force of the spring member 48 is applied to the armature 46 in the X direction. When an electromagnetic force is not generated from the stator core 42, the valve body 46c abuts against the outlet orifice 26a due to the spring force applied from the spring member 48, and closes the outlet orifice 26a. Then, when the solenoid coil 44 is energized, a magnetic flux is generated from the solenoid coil 44, and an electromagnetic force is generated from the stator core 42. The armature 46 is pulled toward the stator core 42 side along the axial direction by the electromagnetic force, and the outlet orifice 26a is opened. When the energization to the solenoid coil 44 is stopped, the electromagnetic force is not generated from the stator core 42, so that the armature 46 moves in the X direction and returns to a position where the valve body 46c closes the outlet orifice 26a.

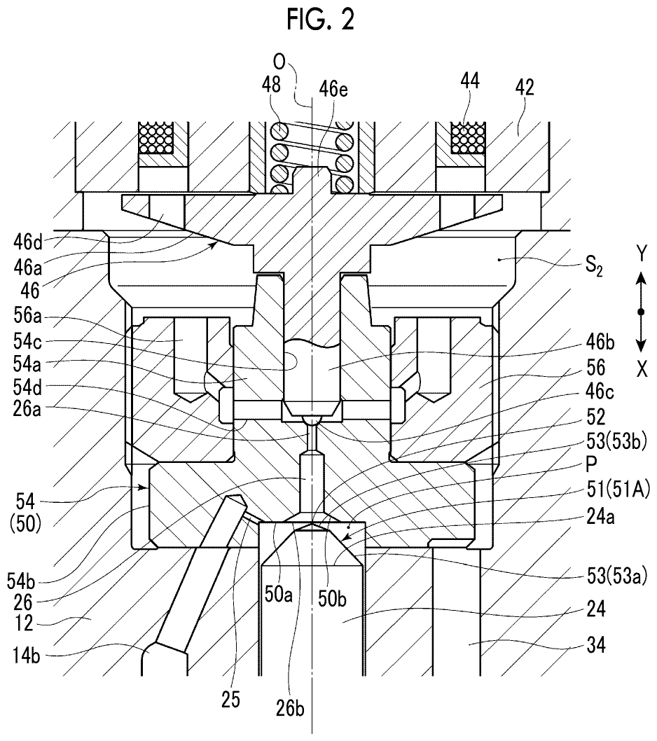

FIG. 2 is a vertical cross-sectional view showing a part of the fuel injection device 10A.

As shown in FIG. 2, the fuel injection device 10A includes a depressurization flow passage formation member 50 (anchor member 54). The depressurization flow passage formation member 50 is formed with an outlet orifice 26a and a facing surface 50a disposed to face the piston surface 24a, and the depressurization flow passage 26 is formed inside the depressurization flow passage formation member 50. An opening 26b through which the depressurization flow passage 26 opens to the pressure control chamber P is formed on the facing surface 50a. Then, a protruding part 51A that protrudes toward the opening 26b is formed on the piston surface 24a. The depressurization flow passage formation member 50 has an inclined surface 50b that is inclined to be tapered as the distance from the opening 26b increases in a direction away from the piston surface 24a. Further, the protruding part 51 has a linear contact portion Lc that can close the opening 26b by linear contact with the inclined surface 50b when the piston surface 24a moves to the Y-direction side.

As described above, when the solenoid actuator 40 is operated to open the outlet orifice 26a, the needle valve 22 moves in the Y direction from a state where the fuel injection hole 16 is closed by the needle valve 22 together with the spool 20, and when the lift amount of the needle valve 22 is at a maximum, at least a part (for example, a tip portion of the protruding part 51A) of the protruding part 51A enters the depressurization flow passage 26 side with respect to the opening 26b. Therefore, when the outlet orifice 26a is opened, the fuel stored in the pressure control chamber P is less likely to be discharged from the opening 26b due to the presence of the protruding part 51 that has entered the depressurization flow passage 26 side with respect to the opening 26b.

In addition, when the piston surface 24a moves to the Y-direction side, the linear contact portion Lc comes into line contact with the inclined surface 50b to close the opening 26b. Therefore, the amount of the fuel discharged to the depressurization flow passage 26 side can be further suppressed. In this way, the presence of the linear contact portion Lc can further reduce the leakage of the fuel from the pressure control chamber P to the depressurization flow passage 26, and thus the injection efficiency can be improved. Further, since the linear contact portion Lc abuts against the inclined surface 50b to form the line contact, the processing accuracy of the linear contact portion Lc can be relatively easily ensured. Therefore, the robustness of the sealing function is good.

In the exemplary embodiment shown in FIG. 2, the spring member 48 is disposed on the central axis O in a space formed in a central portion of the stator core 42, and is configured to be a coil spring extending along the axial direction. Leak holes 46d penetrating the front and back surfaces are formed in the enlarged diameter part 46a of the armature 46. The leak fuel that has flowed from the first space S₁ to the second space S₂ through the leak passage 34 flows out from the discharge port 36 in the direction of the arrow b after passing through the leak hole 46d. On the other hand, even when the leak hole 46d is not provided, the leak fuel can be released to the discharge port 36 from a gap formed between the facing surfaces of the stator core 42 and the armature 46.

In addition, as shown in FIG. 2, the stator core 42 of the solenoid actuator 40 is disposed to surround the spring member 48 on the radial outer side of the spring member 48, and the stator core 42 is disposed on the Y-direction side with respect to the enlarged diameter part 46a of the armature 46 to face the enlarged diameter part 46a.

In addition, a protruding part 46e is formed on the surface of the enlarged diameter part 46a of the armature 46, and the protruding part 46e is inserted into the spring member 48. Therefore, the protruding part 46e facilitates the positioning of the spring member 48. The valve body 46c provided at the tip portion of the shaft portion 46b on the X-direction side is formed in a hemispherical shape, and a spherical surface of the valve body 46c approaches and abuts against the outlet orifice 26a to close the outlet orifice 26a. When the solenoid actuator 40 is operated, the armature 46 is pulled up, the shaft portion 46b moves in the Y direction, and the valve body 46c retreats from the outlet orifice 26a to open the outlet orifice 26a.

Further, in the exemplary embodiment shown in FIG. 2, the anchor member 54 for slidably supporting the shaft portion 46b of the armature 46 along the axial direction is provided. The anchor member 54 is disposed on the side opposite to the stator core 42 with respect to the armature 46 in the axial direction inside the casing 12. The anchor member 54 is configured to include a small-diameter portion 54a and a large-diameter portion 54b that are formed integrally with each other. The large-diameter portion 54b corresponds to the partition wall 12a shown in FIG. 1. A recessed portion 54c into which the shaft portion 46b of the armature 46 is slidably inserted is formed at the central portion of the small-diameter portion 54a, and the outlet orifice 26a is formed on the bottom surface of the recessed portion 54c. The large-diameter portion 54b is formed with the depressurization flow passage 26, a portion of the fuel passage 14b, a portion of the pressure control chamber P, and the like, and a flow path through which the fuel passage 14b communicates with the pressure control chamber P via the inlet orifice 25 is further formed.

In the exemplary embodiment shown in FIG. 2, the depressurization flow passage formation member 50 is configured by the anchor member 54. In another embodiment (not shown), instead of the anchor member 54, the casing 12 may extend to the central portion, and the casing 12 may be formed with the depressurization flow passage 26 having the outlet orifice 26a, the facing surface 50a, and the opening 26b open to the facing surface 50a, a part of the fuel passage 14b, the inlet orifice 25, and a part of the pressure control chamber P.

Further, in the exemplary embodiment shown in FIG. 2, a retaining nut 56 is disposed on the radial outer side of the anchor member 54 to surround the anchor member 54. The outer peripheral surface of the retaining nut 56 threadedly engages with the inner peripheral surface of the casing 12, and the upper surface of the large-diameter portion 54b is locked with the anchor member 54 by the bottom surface of the retaining nut 56. Further, the small-diameter portion 54a is formed with the recess portion 54c and the through-hole 54d that is open to the outer peripheral surface of the small-diameter portion 54a, and the retaining nut 56 is formed with the through-hole 56a that communicates with the through-hole 54d and is open to the second space S₂. The fuel leaking from the outlet orifice 26a to the recess portion 54c flows out to the second space S₂ through the through-holes 54d and 56a.

In the above-described embodiment, the maximum lift amount of the needle valve 22 is defined when the linear contact portion Lc of the protruding part 51 is in linear contact with the inclined surface 50b. Therefore, it is not necessary to define the maximum lift amount of the spool 20 at the needle valve 22 side as in the related art.

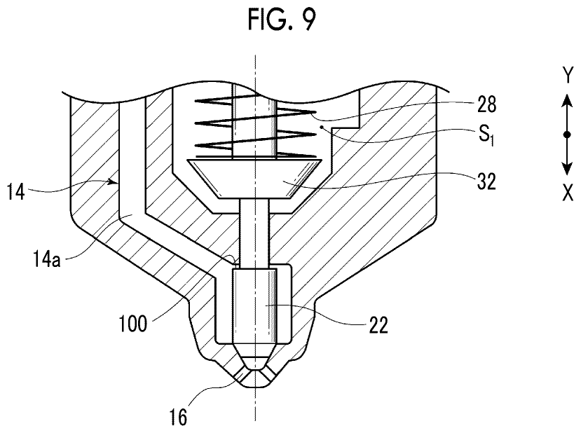

FIG. 9 is a schematic vertical cross-sectional view showing a part of a fuel injection device in the related art.

As shown in FIG. 9, in the fuel injection device of the related art, a step part 100 is formed in the needle valve 22. When the spool 20 moves in the Y direction and the stepped portion 100 abuts against the inner wall surface of the casing 12, the movement of the spool 20 in the Y direction reaches a limit, and the maximum lift amount of the needle valve 22 is reached. Therefore, when the stepped portion 100 abuts against the inner wall surface of the casing 12 and the needle valve 22 reaches the maximum lift amount, there is a case where the protruding part 51 does not abut against the wall surface of the depressurization flow passage formation member 50 forming the opening 26b, and in this case, there is a concern that the amount of fuel leaking from the pressure control chamber P to the depressurization flow passage 26 may increase.

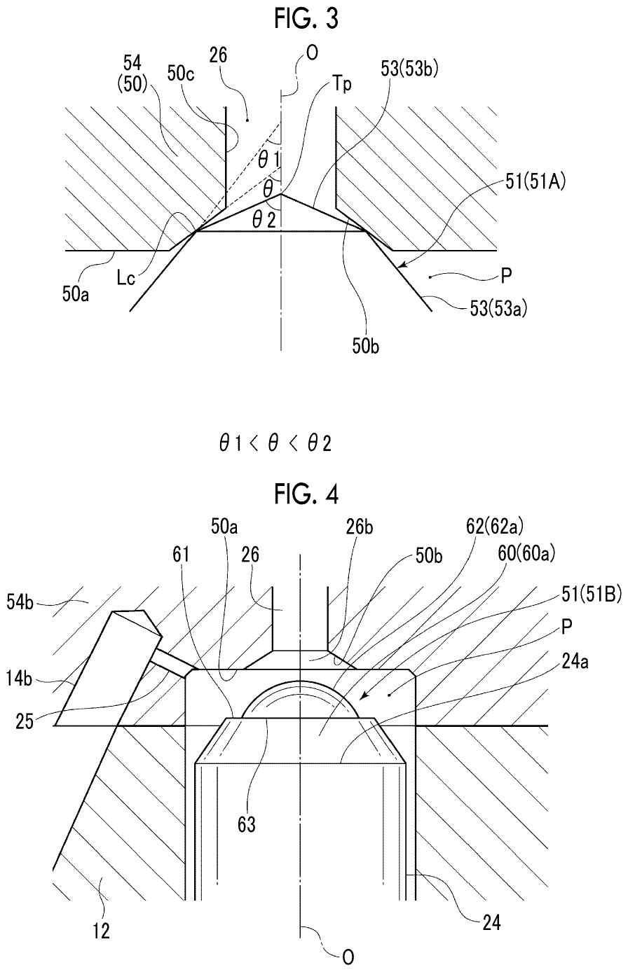

In one embodiment, as shown in FIG. 3, in a cross section including the central axis O of the casing 12, the protruding part 51A has a first inclined surface 53a formed on the piston surface 24a side and a second inclined surface 53b formed on the tip side with respect to the first inclined surface 53a. When an angle of the inclined surface 50b on an acute angle side with respect to the central axis O is θ, an angle of the first inclined surface 53a on an acute angle side with respect to the central axis O is θ1, and an angle of the second inclined surface 53b on an acute angle side with respect to the central axis O is θ2, the angles satisfy a relationship of the following Expression (1). Then, the linear contact portion Lc is formed at a boundary between the first inclined surface 53a and the second inclined surface 53b.

$$θ 1 < θ < θ 2 \qquad ( 1 )$$

According to the present embodiment, the linear contact portion Lc of the protruding part 51A is formed at the boundary between the first inclined surface 53a and the second inclined surface 53b, at which the angle with respect to the central axis O satisfies the above Expression (1), and thus the protruding part 51A having the linear contact portion Lc is easily processed. In addition, since the first inclined surface 53a and the second inclined surface 53b are formed on the surface of the protruding part 51A, the angles of the inclined surfaces are easily managed.

In the exemplary embodiment shown in FIG. 3, in the cross section including the central axis O, the inclined surface 50b, the first inclined surface 53a, and the second inclined surface 53b each have a linear inclined surface, the second inclined surface 53b forms the top portion 52 on the central axis O, and the inclined surfaces each have a shape symmetrical with respect to the central axis O. Therefore, the linear contact portion Lc can completely close the opening 26b without forming a gap between the linear contact portion Lc and the inclined surface 50b, by bringing, on the central axis O, the protruding part 51A close to the opening 26b along the central axis O.

FIG. 4 is an enlarged vertical cross-sectional view showing a part of the fuel injection device according to another embodiment and a vicinity of a pressure control chamber.

As shown in FIG. 4, the protruding part 51B according to the present embodiment includes, in a cross section including the central axis O of the casing 12, a first protruding part 60a having a trapezoidal shape formed on the piston surface 24a, and a second protruding part 62a having an arc-shaped surface formed on a top surface 61 of the first protruding part 60a. The second protruding part 62a has a shape that protrudes to be tapered toward the opening 26b side of the depressurization flow passage 26. In the present embodiment, the linear contact portion Lc is formed by the arc surface of the second protruding part 62a.

In the fuel injection device in the present embodiment, the configuration other than the protruding part 51B is the same as the configuration of the fuel injection device shown in FIG. 2.

According to the present embodiment, the linear contact portion Lc is formed by the arc surface of the second protruding part 62a, the linear contact portion Lc formed by the arc surface abuts against the inclined surface 50b, and thus the opening 26b can be reliably completely closed.

In the exemplary embodiment shown in FIG. 4, the entire back surface 63 of the second protruding part 62a is disposed on the top surface 61 of the first protruding part 60a. Accordingly, since the central axis of the first protruding part 60a and the central axis of the second protruding part 62a can be made to coincide with the central axis O of the casing 12, it is easy to make the central axis of the protruding part 51B coincide with the central axis of the opening 26b. By making the central axis of the protruding part 51B to coincide with the central axis of the opening 26b, the opening 26b can be reliably closed when the protruding part 51B is brought close to the opening 26b.

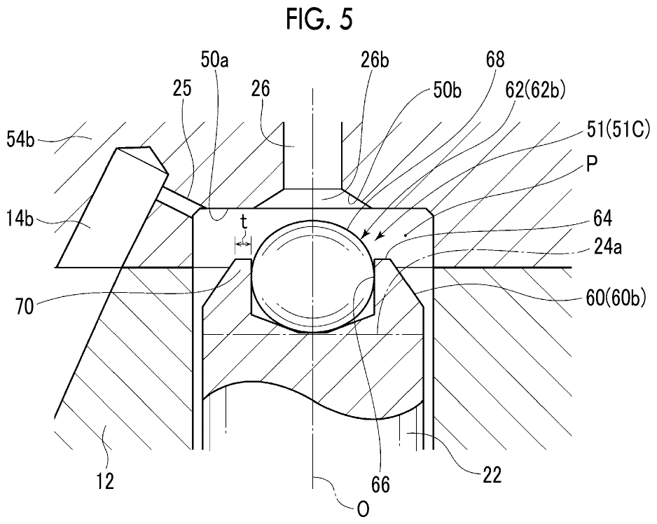

FIG. 5 is an enlarged vertical cross-sectional view showing a part of the fuel injection device according to still another embodiment that is the vicinity of the pressure control chamber.

As shown in FIG. 5, in the protruding part 51C according to the present embodiment, a recess portion 66 is formed in the top surface 64 of the first protruding part 60b formed on the piston surface 24a. The second protruding part 62b is formed from a remaining portion of the sphere 68 of which a part is press-fitted into the recessed portion 66. Therefore, in the present embodiment, the linear contact portion Lc of the protruding part 51C is formed by the spherical surface of the second protruding part 62b.

The fuel injection device in the present embodiment has the same configuration as the configuration of the fuel injection device shown in FIG. 2 except for the configuration of the protruding part 51B.

According to the present embodiment, since the linear contact portion Lc of the protruding part 51C that abuts against the facing surface 50a of the depressurization flow passage formation member 50 in which the opening 26b is formed and closes the opening 26b is formed by the spherical surface of the second protruding part 62b, the linear contact portion Lc can be easily formed, and the sealing degree of the opening 26b can be improved when the opening 26b is closed by the linear contact portion Lc. In addition, since the second protruding part 62b is formed by press-fitting the sphere 68 into the recessed portion 66 formed in the top surface 64 of the first protruding part 60b, the second protruding part 62b is easily formed.

In the exemplary embodiment shown in FIG. 5, the recessed portion 66 is formed to have a circular opening at the center of the piston surface 24a. Then, in the top surface 64, a dam portion 70 having a thickness t is formed at a peripheral edge portion of the recessed portion 66. Since the thickness t of the dam portion 70 is small, the dam portion 70 has elasticity in the radial direction. Therefore, the sphere 68 can be easily press-fitted into the recessed portion 66.

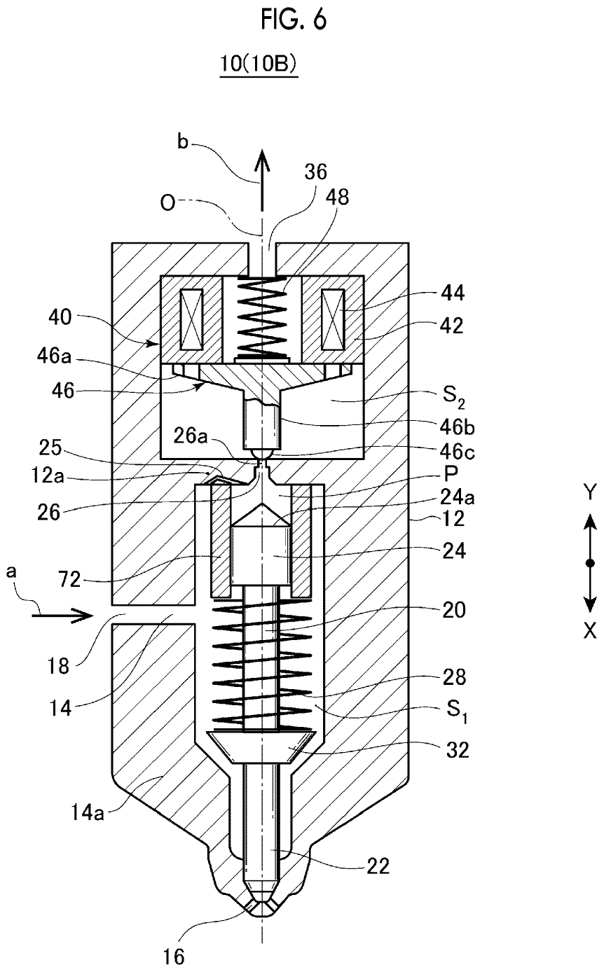

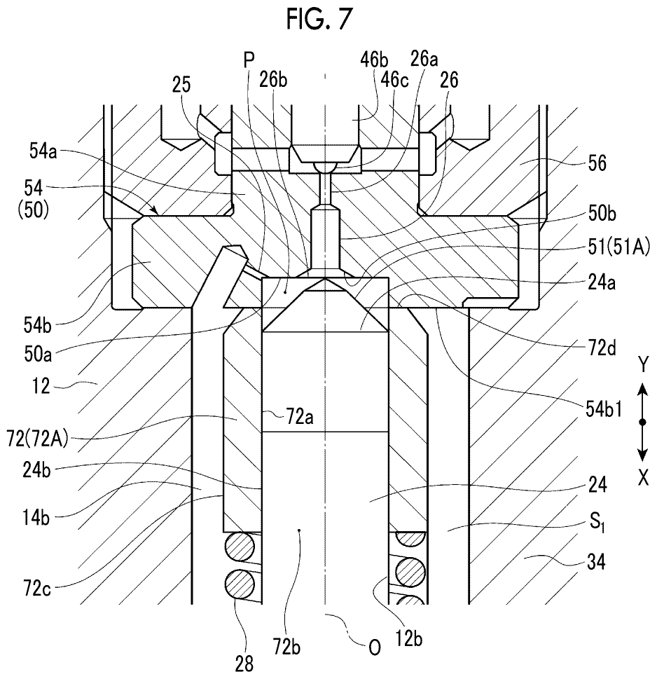

FIG. 6 is a schematic vertical cross-sectional view showing a fuel injection device 10B according to another embodiment, and FIG. 7 is an enlarged vertical cross-sectional view showing a part of the fuel injection device 10B and the vicinity of the pressure control chamber P.

As shown in FIG. 6, the fuel injection device 10B includes a cylindrical sleeve 72 disposed to surround the drive piston 24 on the radial outer side of the drive piston 24. The pressure control chamber P is formed by the partition wall 12a, the piston surface 24a, and the cylindrical sleeve 72. One end side end surface of the cylindrical sleeve 72 in the axial direction is supported by the spring member 28. The spring member 28 biases the spring force to the Y-direction side with respect to the cylindrical sleeve 72, and the cylindrical sleeve 72 is pressed against the partition wall 12a by the spring force of the spring member 28.

Further, a fuel passage 14 through which the fuel inlet port 18 and the first space S₁ communicate with each other is formed, and the high-pressure fuel is supplied from the fuel inlet port 18 to the first space S₁ through the fuel passage 14. The fuel supplied to the first space S₁ flows into the pressure control chamber P through the inlet orifice 25. When the solenoid actuator 40 is operated and the outlet orifice 26a is opened, the fuel in the pressure control chamber P leaks from the depressurization flow passage 26 to the second space S₂, and the pressure control chamber P is depressurized. In this way, a pressure balance between the end of the spool 20 on the X-direction side and the end of the spool 20 on the Y-direction side is disrupted, and the spool 20 moves to the Y-direction side, so that the fuel injection hole 16 is opened and the high-pressure fuel is injected into the combustion chamber (not shown) of the engine. The fuel that has leaked into the second space S₂ is discharged from the discharge port 36 to the outside as indicated by an arrow b. The other configurations are the same as those of the fuel injection device 10A.

As shown in FIG. 7, in the fuel injection device 10B, the partition wall 12a shown in FIG. 6 is configured by the anchor member 54, and the end surface 72d of the cylindrical sleeve 72A is pressed against the one surface 54b1 of the anchor member 54 by the spring force of the spring member 28. The pressure control chamber P is formed by the facing surface 50a of the depressurization flow passage formation member 50, the inner peripheral surface 72a of the cylindrical sleeve 72A, and the piston surface 24a. The drive piston 24 is configured to be in sliding contact with the inner peripheral surface 72a of the cylindrical sleeve 72A in the entire stroke range of the drive piston 24. That is, the inner peripheral surface 72a of the cylindrical sleeve 72A extends over the entire stroke range of the drive piston 24 in the axial direction.

According to the present embodiment, since the cylindrical sleeve 72A is configured to be a member different from the casing 12, the member (that is, the cylindrical sleeve 72A) forming the sliding surface with the outer peripheral surface 24b of the drive piston 24 can be made compact. Therefore, it is easy to perform processing for improving the processing accuracy of the sliding surface. In this way, fuel leakage from the sliding surface can be suppressed. In addition, since the cylindrical sleeve 72A can be taken out from the casing 12 and the damage or wear state of the cylindrical sleeve 72A can be inspected, it becomes easy to perform maintenance and management of the cylindrical sleeve 72A including the sliding surface.

In the exemplary embodiment shown in FIG. 7, the cylindrical sleeve 72A has an opening 72b formed on one end side (X-direction side in the drawing) into which the drive piston 24 is inserted, and the pressure control chamber P is defined between the piston surface 24a and the facing surface 50a formed in the large-diameter portion 54b of the anchor member 54. The large-diameter portion 54b is formed with a portion of the fuel passage 14b, a portion of the pressure control chamber P, an inlet orifice 25 communicating between the fuel passage 14b and the pressure control chamber P, and a portion of the depressurization flow passage 26. In addition, as in the embodiment shown in FIG. 2, the anchor member 54 configures the depressurization flow passage formation member 50.

In addition, the first space S₁ to which the high-pressure fuel is supplied is formed on the radial outer side of the cylindrical sleeve 72A. The end surface 72d of the cylindrical sleeve 72A in the Y direction abuts against the facing surface 54b1 of the large-diameter portion 54b to form a seal surface. In another embodiment (not shown), the end surface 72d may be joined to the facing surface 54b1, or the anchor member 54 and the cylindrical sleeve 72A may be integrally formed. In the present embodiment, it is not necessary to worry about the fuel leakage from the seal surface and the positioning of the cylindrical sleeve 72 with respect to the large-diameter portion 54b.

Further, the cross section of the drive piston 24 and the inner peripheral surface 72a and the outer peripheral surface 72c of the cylindrical sleeve 72A has a circular shape.

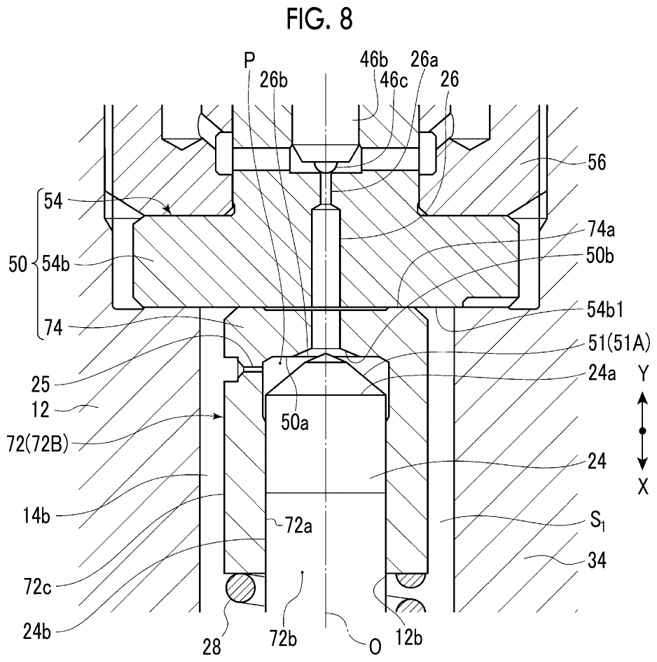

The embodiment shown in FIG. 8 is an embodiment including a cylindrical sleeve 72B disposed to surround the drive piston 24 on the radial outer side of the drive piston 24. The cylindrical sleeve 72B is formed in a bottomed tubular shape having an opening 72b into which the drive piston 24 formed on one end side (X-direction side in the drawing) is inserted and a cover portion 74 formed on the other end side (Y-direction side in the drawing). The pressure control chamber P is defined between the piston surface 24a and one surface of the cover portion 74. Further, the inlet orifice 25 communicating with the fuel passage 14b and the pressure control chamber P is formed in the cylindrical sleeve 72B, and the cover portion 74 is formed with the facing surface 50a facing the piston surface 24a and a portion of the depressurization flow passage 26.

According to the present embodiment, since the cylindrical sleeve 72B is configured as a member different from the casing 12, the member (that is, the cylindrical sleeve 72B) forming the sliding surface with the outer peripheral surface 24b of the drive piston 24 can be made compact. Therefore, it is easy to perform processing for improving the processing accuracy of the sliding surface. In this way, fuel leakage from the sliding surface can be suppressed. In addition, since the cylindrical sleeve 72B can be taken out from the casing 12 and the damage or wear state of the cylindrical sleeve 72B can be inspected, it becomes easy to perform maintenance and management of the cylindrical sleeve 72B including the cover portion 74.

In the exemplary embodiment shown in FIG. 8, the first space S₁ to which the high-pressure fuel is supplied is formed on the radial outer side of the cylindrical sleeve 72B. The end surface 72d of the cylindrical sleeve 72B in the Y direction abuts against the facing surface 54b1 of the large-diameter portion 54b to form a seal surface. In addition, the end surface 74a of the cover portion 74 in the Y direction is pressed against the facing surface 54b1 of the large-diameter portion 54b of the anchor member 54 by the spring force of the spring member 28 to form a seal surface. In another embodiment (not shown), the end surface 74a may be joined to the facing surface 54b1, or the anchor member 54 and the cylindrical sleeve 72B may be integrally formed. Further, the cross section of the outer peripheral surface of the drive piston 24 and the inner peripheral surface 72a and the outer peripheral surface 72c of the cylindrical sleeve 72B each have a circular shape.

In the exemplary embodiment shown in FIG. 8, the depressurization flow passage formation member 50 includes an anchor member 54 in which the outlet orifice 26a and a portion of the depressurization flow passage 26 are formed, and a plate-shaped cover portion 74 that is formed in the cylindrical sleeve 72B and in which a portion of the depressurization flow passage 26, the facing surface 50a, and the opening 26b formed in the facing surface 50a are formed.

For example, contents described in each of the above-described embodiments are understood as follows.
1) A fuel injection device configured to inject fuel by a solenoid actuator (40), the fuel injection device (10) including: a casing (12) in which a fuel injection hole (16) is formed in a tip portion and a fuel passage (14) that allows the fuel injection hole (16) and a fuel inlet port (18) to communicate with each other is formed inside the casing (12); a spool (20) disposed inside the casing (12) to be movable along an axial direction of the casing (12) by operation of the solenoid actuator (40), the spool (20) including:
   a needle valve (22) disposed on one end side of the spool (20) to be capable of opening and closing the fuel injection hole (16), and
   a drive piston (24) having a piston surface (24a) disposed on the other end side of the spool (20) to face a pressure control chamber (P) that communicates with the fuel passage (14); and
a depressurization flow passage formation member (50) having an outlet port (26a) that is opened and closed by the operation of the solenoid actuator (40) and an opening (26b) formed on a facing surface (50a) facing the piston surface (24a), the depressurization flow passage formation member (50) having a depressurization flow passage (26) that communicates with the pressure control chamber (P) and that is formed inside the depressurization flow passage formation member (50),
wherein the piston surface (24a) has a protruding part (51) that protrudes toward an opening (26b) side, and the depressurization flow passage formation member (50) has an inclined surface (50b) that is inclined from the opening (26b) to be tapered in a direction away from the piston surface (24a), and
the protruding part (51) has a linear contact portion (Lc) that comes into linear contact with the inclined surface (50b) and is capable of closing the opening (26b) when the piston surface (24a) is moved to the other end side.

In such a configuration, when the solenoid actuator (40) is operated to open the outlet port (26a) of the depressurization flow passage (26), the fuel in the pressure control chamber (P) is discharged from the depressurization flow passage (26) and the pressure control chamber (P) is depressurized, so that a pressure imbalance occurs between the pressure control chamber (P) and the needle valve (22) side. In this way, the spool (20) moves to the pressure control chamber (P) side, the fuel injection hole (16) is opened, and the fuel is injected from the fuel injection hole (16). When the solenoid actuator (40) is deactivated and the outlet port (26a) of the depressurization flow passage (26) is closed, the pressure control chamber (P) and the pressure on the needle valve (22) side are balanced, so that the spool (20) moves to the fuel injection hole (16) side, and the fuel injection hole (16) is closed by the needle valve (22).

The piston surface (24a) includes a protruding part (51) that protrudes toward the opening (26b) side, and the protruding part (51) is configured such that at least a portion of the protruding part (51) enters the depressurization flow passage (26) side from the opening (26b) side in a state where the spool (20) moves from one end side to the other end side of the spool (20) and thus the lift amount of the needle valve (22) is at a maximum. Therefore, when the outlet port (26a) is opened, the fuel stored in the pressure control chamber (P) is less likely to be discharged from the opening (26b) to the depressurization flow passage (26) by the protruding part (51) that has entered the depressurization flow passage (26) side with respect to the opening (26b).

In addition, the depressurization flow passage formation member (50) has the inclined surface (50b), the protruding part (51) includes the linear contact portion (Lc), and when the piston surface (24a) moves to the other end side, the linear contact portion (Lc) comes into line contact with the inclined surface (50b) to close the opening (26b), and thus the amount of the fuel discharged to the depressurization flow passage (26) side can be further suppressed. In this way, the presence of the linear contact portion (Lc) can further reduce the amount of leakage of the fuel discharged from the pressure control chamber (P) to the depressurization flow passage (26), and thus the injection efficiency can be improved. Further, since the linear contact portion (Lc) abuts against the inclined surface (50b) to form the line contact, the processing accuracy of the linear contact portion (Lc) can be relatively easily ensured. Therefore, the robustness of the sealing function is good.
2) According to another aspect, in the fuel injection device (10) according to 1), in a cross section including a central axis (O) of the casing (12), the protruding part (51A) includes a first inclined surface (53a) formed on a piston surface (24a) side and a second inclined surface (53b) formed on a tip side with respect to the first inclined surface (53a),
when an angle of the inclined surface (50b) on an acute angle side with respect to the central axis (O) is θ, an angle of the first inclined surface (53a) on the acute angle side with respect to the central axis (O) is θ1, and an angle of the second inclined surface (53b) on the acute angle side with respect to the central axis (O) is θ2, a relationship of the following Expression (1) is satisfied, and
the linear contact portion (Lc) is formed at a boundary between the first inclined surface (53a) and the second inclined surface (53b).

$$θ 1 < θ < θ 2 \qquad ( 1 )$$

According to such a configuration, the linear contact portion (Lc) of the protruding part (51A) is formed at the boundary between the first inclined surface (53a) and the second inclined surface (53b) having the angle satisfying Expression (1), and thus the protruding part (51) forming the linear contact portion (Lc) is easily processed. In addition, since the first inclined surface (53a) and the second inclined surface (53b) are formed on the surface of the protruding part (51A), the angles of the inclined surfaces are easily managed.
3) According to still another aspect, in the fuel injection device (10) according to 1), in a cross section including a central axis (O) of the casing (12), the protruding part (51B) includes
   a first protruding part (60a) having a trapezoidal shape formed on the piston surface (24a), and
   a second protruding part (62a) having an arc shape formed on a top surface (61) of the first protruding part (60a), the second protruding part (62a) protruding to be tapered toward an opening (26b) side of the depressurization flow passage (26), and
the linear contact portion (Lc) is formed by an arc surface of the second protruding part (62a).

According to such a configuration, the linear contact portion (Lc) is formed by the arc surface of the second protruding part (62a), and the complete closing of the opening (26b) can be reliably performed by the linear contact portion formed by the arc surface.
4) In the fuel injection device according to still another aspect, in the fuel injection device (10) according to 3), a recessed portion (66) is formed in the top surface (64) of the first protruding part (60b), and
the second protruding part (62b) is formed from a remaining portion of a sphere (68) of which a part is press-fitted into the recessed portion (66).

According to such a configuration, the linear contact portion (Lc) of the protruding part (51C) that abuts against the inclined surface (50b) formed in the depressurization flow passage formation member (50) to close the opening (26b) is formed by the spherical surface of the second protruding part (62a), and thus the linear contact portion (Lc) can be easily formed, and the sealing degree of the opening (26b) can be improved. In addition, since the second protruding part (62b) is formed by press-fitting the sphere (68) into the recessed portion (66) formed in the top surface (64) of the first protruding part (60b), the protruding part (51C) is easily formed.
5) The fuel injection device according to still another aspect is the fuel injection device (10) according to any one of 1) to 4), and further includes a cylindrical sleeve (72) disposed to surround the drive piston (24) on a radial outer side of the drive piston (24),
in which the drive piston (24) is in sliding contact with an inner peripheral surface (72a) of the cylindrical sleeve (72) in an entire stroke range of the drive piston (24).

According to such a configuration, since the cylindrical sleeve (72) is configured by a member different from the casing (12), the member forming the sliding surface with the outer peripheral surface (24b) of the drive piston (24), that is, the cylindrical sleeve (72), can be made compact. Therefore, processing for improving the processing accuracy of the sliding surface is facilitated, and thus fuel leakage from the sliding surface can be suppressed. In addition, since the cylindrical sleeve (72) can be taken out from the casing (12) and the damage or wear state can be inspected, it becomes easy to perform maintenance and management of the cylindrical sleeve (72A) including the sliding surface.
6) A fuel injection device according to still another aspect is the fuel injection device (10) according to 5), in which the cylindrical sleeve (72B) is formed in a bottomed tubular shape having an opening (72b) into which the drive piston (24) formed on one end side is inserted and a cover portion (74) formed on the other end side,
the pressure control chamber (P) is defined between the piston surface (24a) and the cover portion (74),
an inlet orifice (25) communicating with the fuel passage (14b) and the pressure control chamber (P) is formed in the cylindrical sleeve (72B), and
the cover portion (74) is formed with the facing surface (50a) facing the piston surface (24a) and at least a part of the depressurization flow passage (26).

According to such a configuration, the cylindrical sleeve (72B) can be configured by a member different from the casing (12), and thus the member (that is, the cylindrical sleeve (72)) forming the outer peripheral surface and the sliding surface of the drive piston (24) can be made compact. Therefore, the machining accuracy of the sliding surface can be improved. In addition, since the cylindrical sleeve (72A) can be taken out from the casing (12) and the damage or wear state can be inspected, it becomes easy to perform maintenance and management of the cylindrical sleeve (72A) including the cover portion (74) in which the sliding surface and the depressurization flow passage (26) are formed.

### REFERENCE SIGNS LIST

10 (10A, 10B): fuel injection device
12: casing
12a: partition wall
12b: inner peripheral surface
14 (14a, 14b): fuel passage
16: fuel injection hole
18: fuel inlet port
20: spool
22: needle valve
24: drive piston
24a: piston surface
24b: outer peripheral surface
25: inlet orifice
26: depressurization flow passage
26a: outlet orifice (outlet port)
26b: opening
28, 48: spring member
30, 100: step part
32: support platform
34: leak passage
36: discharge port
40: solenoid actuator
42: stator core
44: solenoid coil
46: armature
46a: enlarged diameter part
46b: shaft portion
46c: valve body
46d: leak hole
46e: protruding part
50: depressurization flow passage formation member
50a: facing surface
50b: inclined surface
51 (51A, 51B, 51C): protruding part
52: top portion
53 (53a, 53b): inclined surface
54: anchor member
54a: small-diameter portion
54b: large-diameter portion
54b1: facing surface
54c: recessed portion
54d: through-hole
56: retaining nut
56a: through-hole
60a, 60b: first protruding part
61, 64: top surface
62a, 62b: second protruding part
63: back surface
66: recessed portion
68: sphere
70: dam portion
72 (72A, 72B): cylindrical sleeve
72a: inner peripheral surface
72b: opening
72c: outer peripheral surface
72d: end surface
74: cover portion
74a: end surface
O: central axis
P: pressure control chamber
S₁: first space
S₂: second space

1. A fuel injection device configured to inject fuel by a solenoid actuator, the fuel injection device comprising:
a casing in which a fuel injection hole is formed in a tip portion and a fuel passage that allows the fuel injection hole and a fuel inlet port to communicate with each other is formed inside the casing;
a spool disposed inside the casing to be movable along an axial direction of the casing by operation of the solenoid actuator, the spool including
a needle valve disposed on one end side of the spool to be capable of opening and closing the fuel injection hole, and
a drive piston having a piston surface disposed on the other end side of the spool to face a pressure control chamber that communicates with the fuel passage; and
a depressurization flow passage formation member having an outlet port that is opened and closed by the operation of the solenoid actuator and an opening formed on a facing surface facing the piston surface, the depressurization flow passage formation member having a depressurization flow passage that communicates with the pressure control chamber and that is formed inside the depressurization flow passage formation member,
wherein the piston surface has a protruding part that protrudes toward an opening side, and the depressurization flow passage formation member has an inclined surface that is inclined from the opening to be tapered in a direction away from the piston surface, and
the protruding part has a linear contact portion that comes into linear contact with the inclined surface and is capable of closing the opening when the piston surface is moved to the other end side.

2. The fuel injection device according to claim 1,
wherein in a cross section including a central axis of the casing, the protruding part includes a first inclined surface formed on a piston surface side and a second inclined surface formed on a tip side with respect to the first inclined surface,
when an angle of the inclined surface on an acute angle side with respect to the central axis is θ, an angle of the first inclined surface on the acute angle side with respect to the central axis is θ1, and an angle of the second inclined surface on the acute angle side with respect to the central axis is θ2, a relationship of the following Expression (1) is satisfied, and
the linear contact portion is formed at a boundary between the first inclined surface and the second inclined surface.
$$θ1 < θ < θ2 . \qquad ( 1 )$$

3. The fuel injection device according to claim 1,
wherein in a cross section including a central axis of the casing, the protruding part includes
a first protruding part having a trapezoidal shape formed on the piston surface, and
a second protruding part having an arc shape formed on a top surface of the first protruding part, the second protruding part protruding to be tapered toward the opening side of the depressurization flow passage, and
the linear contact portion is formed by an arc surface of the second protruding part.

4. The fuel injection device according to claim 3,
wherein a recessed portion is formed in the top surface of the first protruding part, and
the second protruding part is formed from a remaining portion of a sphere of which a part is press-fitted into the recessed portion.

5. The fuel injection device according to claim 1, further comprising:
a cylindrical sleeve disposed to surround the drive piston on a radial outer side of the drive piston,
wherein the drive piston is in sliding contact with an inner peripheral surface of the cylindrical sleeve in an entire stroke range of the drive piston.

6. The fuel injection device according to claim 5
wherein the cylindrical sleeve is formed in a bottomed tubular shape having an opening into which the drive piston formed on one end side is inserted and a cover portion formed on the other end side,
the pressure control chamber is defined between the piston surface and the cover portion,
an inlet orifice communicating with the fuel passage and the pressure control chamber is formed in the cylindrical sleeve, and
the cover portion is formed with the facing surface facing the piston surface and at least a part of the depressurization flow passage.
